(19) United States
(12) Patent Application Publication
(10) Pub. No.: US 2026/0161112 A1
(43) Pub. Date: Jun. 11, 2026

(54) IMAGE FORMING APPARATUS

(71) Applicant: CANON KABUSHIKI KAISHA, Tokyo (JP)

(72) Inventor: Kosuke Takeuchi, Chiba (JP)

(21) Appl. No.: 19/179,129

(22) Filed: Apr. 15, 2025

(30) Foreign Application Priority Data
Jun. 10, 2024 (JP) 2024-093929
Feb. 21, 2025 (JP) 2025-026667

(51) Int. Cl. G03G 15/08; G03G 15/00

(52) U.S. Cl. CPC G03G 15/0856; G03G 15/0808; G03G 15/0872; G03G 15/502; G03G 15/556

(57) ABSTRACT

An image forming apparatus including: a toner amount detection portion; a toner cartridge; a driving portion; a controller; a temperature detection portion; and a display, in which the controller executes a first operation of controlling the driving portion to rotationally drive the toner cartridge under a first rotation condition for replenishing the toner container with toner, and in a case where the toner amount detected by the toner amount detection portion is smaller than a predetermined amount after the first operation is executed, based on the temperature detected by the temperature detection portion, determines whether to execute a second operation of controlling the driving portion to rotationally drive the toner cartridge under a second rotation condition different from the first rotation condition, or execute a third operation of controlling the display to perform a display for prompting replacement of the toner container without executing the second operation.

### BACKGROUND OF THE INVENTION

### Field of the Invention

The present invention relates to an image forming apparatus.

### Description of the Related Art

In an image forming apparatus that forms an image by supplying toner as a developer from a toner cartridge, there is an image forming apparatus that performs control called a toner squeezing sequence.

In the toner cartridge, an internal plate-like member is rotationally driven by an external driving source, and the toner accommodated in the toner cartridge is discharged to the outside and supplied to a developing unit of the image forming apparatus, and then the toner cartridge is replaced by a user when it becomes empty of toner.

As described in US 2014/0044442 A1, the toner squeezing sequence is an operation of changing the rotation speed of the toner cartridge and discharging the toner in the toner cartridge immediately before the toner amount in the toner cartridge decreases and a replacement instruction of the toner cartridge is issued. As a result, the toner discharge performance of the toner cartridge is improved, the remaining amount of toner remaining in the toner cartridge at the time of replacing the toner cartridge is reduced, and waste of toner remaining in the toner cartridge and replaced without being used is reduced.

As an example of the toner squeezing sequence, in a case where the rotation speed of the toner cartridge is high, since the toner is pressed against the outer peripheral portion of the toner cartridge by the centrifugal force and is difficult to be discharged, the toner squeezing sequence of intentionally reducing the rotation speed is performed to improve the discharge ability of the toner from the toner cartridge.

However, when the toner squeezing sequence as in this example is performed, an image defect such as a development stain may occur.

In a case where the toner cartridge is left under a high-temperature and high-humidity environment for a long period of time, a large number of clusters of agglomerates are formed in the toner, and when the rotation speed of the toner cartridge is high, the clusters of agglomerates are pressed against the outer peripheral portion of the toner cartridge by a centrifugal force and are difficult to discharge, so that the toner remaining in the toner cartridge to the end has a high proportion of the clusters of agglomerates. In this state, when the toner squeezing sequence for reducing the rotation speed of the toner cartridge is performed, the centrifugal force becomes small and the clusters of agglomerates pressed against the outer peripheral portion of the toner cartridge are discharged, and when the clusters of agglomerates enter the developing unit of the image forming apparatus, there is a possibility that an image defect such as a development stain occurs.

### SUMMARY OF THE INVENTION

It is desirable in the present invention to improve the discharge ability of toner from a toner cartridge and to suppress the occurrence of image defects.

An aspect of the present invention is an image forming apparatus comprising:
an image bearing member;
a toner container configured to accommodate toner;
a developer carrier configured to carry a developer including the toner to develop an electrostatic latent image formed on the image bearing member;
a toner amount detection portion configured to detect an amount of the toner accommodated in the toner container;
a rotatable toner cartridge configured to accommodate toner for replenishing the toner container;
a driving portion configured to rotationally drive the toner cartridge;
a controller configured to control the driving portion;
a temperature detection portion configured to detect temperature; and
a display,
wherein
the controller executes a first operation of controlling the driving portion to rotationally drive the toner cartridge under a first rotation condition for replenishing the toner container with toner, and
in a case where the toner amount detected by the toner amount detection portion is smaller than a predetermined amount after the first operation is executed, based on the temperature detected by the temperature detection portion, determines whether to execute a second operation of controlling the driving portion to rotationally drive the toner cartridge under a second rotation condition different from the first rotation condition, or execute a third operation of controlling the display to perform a display for prompting replacement of the toner container without executing the second operation.

Another aspect of the present invention is an image forming apparatus comprising:
an image bearing member;
a toner container configured to accommodate toner;
a developer carrier configured to carry a developer including the toner to develop an electrostatic latent image formed on the image bearing member;
a toner amount detection portion configured to detect an amount of the toner accommodated in the toner container;
a rotatable toner cartridge configured to accommodate toner for replenishing the toner container;
a driving portion configured to rotationally drive the toner cartridge;
a controller configured to control the driving portion; and
a temperature detection portion configured to detect temperature,
wherein
the controller executes a first operation of controlling the driving portion to rotationally drive the toner cartridge at a first rotation speed for replenishing the toner container with toner, and
in a case where the toner amount detected by the toner amount detection portion is smaller than a predetermined amount after the first operation is executed, based on the temperature detected by the temperature detection portion, determines whether to execute a second operation of controlling the driving portion to rotationally drive the toner cartridge at a second rotation speed lower than the first rotation speed, or execute a third operation of controlling the driving portion to rotationally drive the toner cartridge at a third rotation speed higher than the second rotation speed.

Further features of the present invention will become apparent from the following description of exemplary embodiments with reference to the attached drawings.

### BRIEF DESCRIPTION OF THE DRAWINGS

FIG. 1 is a schematic front cross-sectional configuration diagram of an image forming apparatus according to a first embodiment of the present invention.

FIG. 2 is a cross-sectional view illustrating a configuration of a developing device and a replenishment device according to the first embodiment of the present invention.

FIG. 3 is a cross-sectional view of the toner cartridge of the replenishment device according to the first embodiment of the present invention as viewed from a direction perpendicular to a rotation axis.

FIG. 4 is a schematic view of the toner cartridge according to the first embodiment of the present invention as viewed from the side in parallel with the rotation axis.

FIG. 5 is a cross-sectional view of the toner cartridge viewed from a direction perpendicular to a rotation axis when a rotation speed of the toner cartridge according to the first embodiment of the present invention is set to a low speed.

FIG. 6 is a circuit block diagram for controlling the image forming apparatus of FIG. 1 according to the first embodiment of the present invention.

FIG. 7 is a flowchart of the control device of FIG. 6 illustrating a replenishment operation of the replenishment device according to the first embodiment of the present invention.

FIG. 8 is a flowchart illustrating a replenishment operation of a replenishment device in a comparative example.

FIG. 9 is a table showing verification results of the first embodiment of the present invention and the comparative example.

FIG. 10 is a diagram illustrating a classification of an environment in which the toner squeezing sequence according to a second embodiment of the present invention is performed and an environment in which the toner squeezing sequence is not performed.

FIG. 11 is a flowchart of the control device of FIG. 6 illustrating a replenishment operation of the replenishment device according to the second embodiment of the present invention.

FIG. 12 is a table showing verification results of the second embodiment of the present invention and the comparative example.

FIG. 13 is a flowchart of the control device of FIG. 6 illustrating a replenishment operation of the replenishment device according to a third embodiment of the present invention.

FIG. 14 is a table showing verification results of the third embodiment of the present invention and the comparative example.

FIG. 15 is a flowchart of the control device of FIG. 6 illustrating a replenishment operation of the replenishment device according to a fourth embodiment of the present invention.

FIG. 16 is a table showing verification results of the fourth embodiment of the present invention and the comparative example.

FIG. 17 is a flowchart of the control device of FIG. 6 illustrating a replenishment operation of the replenishment device according to a fifth embodiment of the present invention.

FIG. 18 is a table showing verification results of the fifth embodiment of the present invention and the comparative example.

### DESCRIPTION OF THE EMBODIMENTS

Hereinafter, preferred embodiments of the present invention will be exemplarily described in detail with reference to the drawings. However, the constituent elements described in the following embodiments are merely examples, and various conditions such as a configuration, a function, a dimension, a material, a shape, a relative arrangement, and the like of an apparatus to which the present invention is applied can be appropriately modified or changed without departing from the gist of the present invention, and are not limited to the following embodiments. Therefore, the scope of the present invention is not intended to be limited to them unless otherwise specified.

### First Embodiment

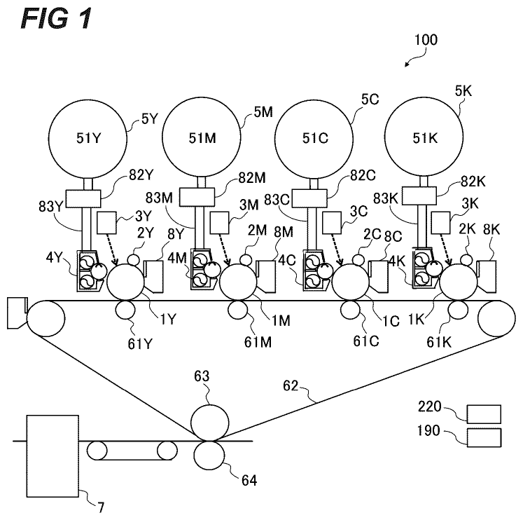

FIG. 1 is a schematic front cross-sectional configuration diagram of an image forming apparatus according to a first embodiment of the present invention.

In FIG. 1, an image forming apparatus 100 serving as an image forming unit is a laser beam printer using a tandem type-intermediate transfer type electrophotographic process in which photosensitive drums 1Y, 1M, 1C, and 1K as image bearing members that form toner images of four colors of yellow (Y), magenta (M), cyan (C), and black (K) are arranged along a rotation direction of an intermediate transfer belt 62.

The image formation in the image forming apparatus 100 is performed in the following steps.

First, the surfaces of the photosensitive drums 1Y, 1M, 1C, and 1K are uniformly charged by charging devices 2Y, 2M, 2C, and 2K. The surfaces of the charged photosensitive drums 1Y, 1M, 1C, and 1K are exposed by exposure devices 3Y, 3M, 3C, and 3K, whereby electrostatic latent images are formed on the photosensitive drums 1Y, 1M, 1C, and 1K. Toners of respective colors of yellow (Y), magenta (M), cyan (C), and black (K) from developing devices 4Y, 4M, 4C, and 4K are attached to the electrostatic latent images thus obtained, thereby developing the electrostatic latent images as toner images.

These toner images are transferred onto the intermediate transfer belt 62 in .an overlapping manner by primary transfer rollers 61Y, 61M, 61C, and 61K. Then, the toner images of the four colors of yellow (Y), magenta (M), cyan (C), and black (K) are transferred onto the intermediate transfer belt 62 in an overlapping manner, and then transferred as a color toner image onto a recording medium conveyed from a sheet cassette (not illustrated) to a secondary transfer portion where a secondary transfer roller 63 and a secondary transfer outer roller 64 abut on each other through a conveying roller (not illustrated).

The recording medium is heated and pressed by a fixing device 7 to fix the color toner image on the recording medium to the recording medium and then discharged to the outside of the image forming apparatus 100.

Residual toner remaining on the photosensitive drums 1Y, 1M, 1C, and 1K after the transfer is removed by cleaning devices 8Y, 8M, 8C, and 8K.

In addition, an image forming apparatus temperature detection device 190 of the temperature detection portion serving as the temperature detection unit that is the agglomerate determination unit includes a temperature sensor, is attached to an outer wall portion of the image forming apparatus (not illustrated) and detects the temperature of the atmosphere around the image forming apparatus 100.

In addition, an image forming apparatus humidity detection device 220 of the humidity detection portion serving as the humidity detection unit that is the agglomerate determination unit includes a moisture amount sensor, is attached to an outer wall portion of the image forming apparatus (not illustrated) and detects the moisture amount of the atmosphere around the image forming apparatus 100. Then, the humidity of the atmosphere around the image forming apparatus 100 is detected together with the temperature detected by the image forming apparatus temperature detection device 190.

Replenishment devices 5Y, 5M, 5C, and 5K are provided corresponding to the developing devices 4Y, 4M, 4C, and 4K, and toner cartridges 51Y, 51M, 51C, and 51K containing toners corresponding to respective colors of yellow (Y), magenta (M), cyan (C), and black (K) are replaceably loaded. Toner storages (toner containers) 82Y, 82M, 82C, and 82K serving as toner storage units are configured to temporarily store toners of the respective colors of the toner cartridges 51Y, 51M, 51C, and 51K supplied from the replenishment devices 5Y, 5M, 5C, and 5K, respectively, and convey (replenish) the toners to the developing devices 4Y, 4M, 4C, and 4K corresponding to the colors of the respective developers.

For example, the proportional weight of toner of the developer stored in the toner cartridges 51Y, 51M, 51C, and 51K is 80 to 95%, and the proportional weight of toner of the developer in the developing devices 4Y, 4M, 4C, and 4K is 5 to 10%. Therefore, when toner is consumed by development in the developing devices 4Y, 4M, 4C, and 4K, there is replenishment with toner corresponding to the consumption amount from the toner storages 82Y, 82M, 82C, and 82K, and the proportional weight of toner of the developer in the developing devices 4Y, 4M, 4C, and 4K is maintained constant.

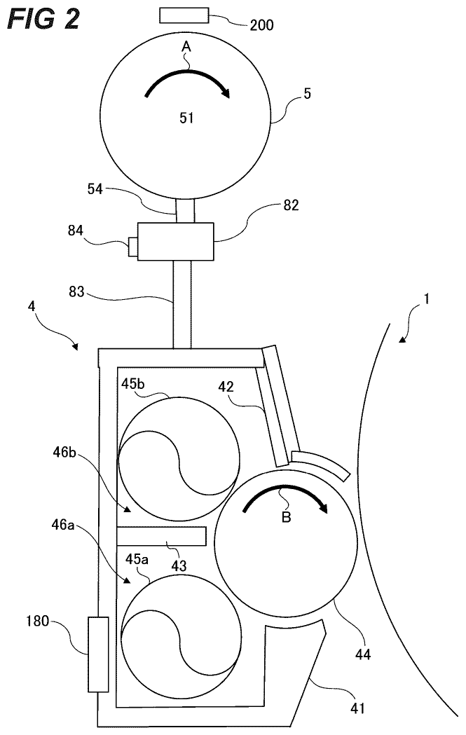

Next, details of the developing devices 4Y, 4M, 4C, and 4K and the replenishment devices 5Y, 5M, 5C, and 5K in FIG. 1 will be described with reference to FIG. 2. Since the developing devices 4Y, 4M, 4C, and 4K and the replenishment devices 5Y, 5M, 5C, and 5K have the same configuration, reference signs of Y, M, C, and K are omitted, and only numbers are shown in the following description.

FIG. 2 is a cross-sectional view illustrating configurations of the developing device 4 and the replenishment device 5.

In FIG. 2, the developing device 4 includes a developing roller 44 as a developer carrier including a magnetic field generation unit fixedly disposed and a nonmagnetic developing sleeve rotating on an outer peripheral portion of the magnetic field generation unit, a regulating member 42 that regulates a height of a magnetic brush formed on the developing roller 44, and a developing container 41 that accommodates a developer.

Further, the developing container 41 is partitioned into a first developer conveying path 46a and a second developer conveying path 46b by a partition wall 43 extending in the horizontal direction, and these communicate with each other by communication ports at both ends. Thus, a circulation path of the developer is formed by the first developer conveying path 46a and the second developer conveying path 46b. A first screw 45a is disposed in the first developer conveying path 46a, and a second screw 45b is disposed in the second developer conveying path 46b. The first screw 45a stirs toner replenished from a toner replenishment port (not illustrated) and the developer in the first developer conveying path 46a and conveys the toner to one side to equalize the toner density. The second screw 45b stirs the developer in the second developer conveying path 46b and conveys the developer to the other side. Thus, the developer is circulated between the first developer conveying path 46a and the second developer conveying path 46b.

In addition, a developing device temperature detection device 180 of the temperature detection portion serving as the temperature detection unit that is the agglomerate determination unit includes a temperature sensor, is attached to the outside of the developing device, and detects the temperature of the atmosphere around the developing device 4.

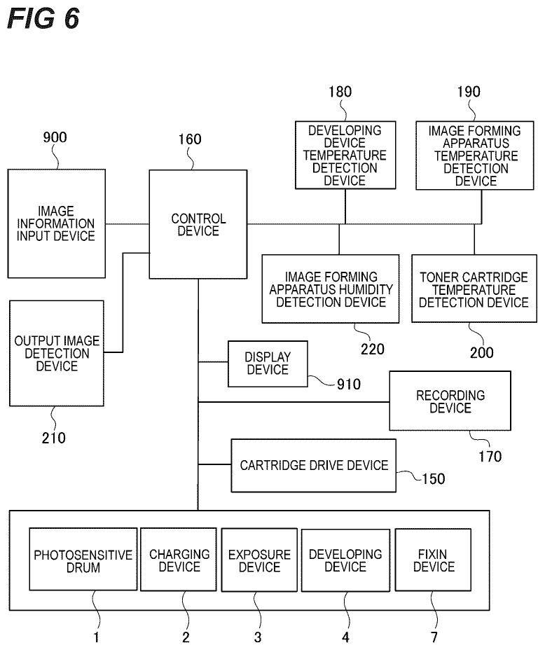

The replenishment device 5 includes a toner cartridge 51 and an in-toner cartridge toner discharge path 54. The toner in the toner cartridge 51 is conveyed to the toner storage 82 through the in-toner cartridge toner discharge path 54 when a cartridge driving device 150 serving as a cartridge driving unit which is a driving portion for rotationally driving the toner cartridge 51 illustrated in FIG. 6 of the replenishment device 5 rotationally drives the toner cartridge 51.

The toner storage 82 includes a toner detection sensor 84 serving as a toner detection unit that is a toner amount detection portion that detects the toner amount in the toner storage 82 and supplies the toner to the toner storage 82 by rotationally driving the toner cartridge 51 when the detection result of the toner detection sensor 84 indicates shortage of toner. The toner storage 82 appropriately replenishes toner to the developing device 4 through a replenishment conveyance path 83.

In the first to fifth embodiments to be described below, the image forming apparatus 100 includes the toner storage 82, and in a case where the toner amount in the toner storage 82 is smaller than a predetermined amount, the toner cartridge 51 is rotationally driven to supply the toner to the developing container 41. As a result, a configuration in which the toner is conveyed from the toner cartridge 51 to the developing container 41 via the toner storage 82 will be described as an example, but the present invention is not limited thereto.

In a configuration in which the image forming apparatus 100 does not include the toner storage 82, there may be a modification in which the toner is directly conveyed from the toner cartridge 51 to the developing container 41. In this modification, in a case where the toner amount in the developing container 41 is smaller than a predetermined amount, the toner cartridge 51 is rotationally driven to supply the toner to the developing container 41.

The toner storage 82 has a capacity of about ⅓ of the toner cartridge 51 and can store a certain amount of toner. Therefore, the toner can be appropriately supplied to the developing device 4 even while the user replaces the toner cartridge 51, and the toner cartridge 51 can be replaced without stopping the image formation.

Note that, in the first to fifth embodiments to be described below, an example in which the capacity of the toner storage 82 is about ⅓ of the capacity of the toner cartridge 51 will be described, but a modification in which the capacity of the toner storage 82 is larger than the capacity of the toner cartridge 51 may be used.

A toner cartridge temperature detection device 200 of a temperature detection portion serving as a temperature detection unit that is an agglomerate determination unit, is attached to the upper portion of the toner cartridge 51 in the replenishment device 5 and detects the temperature of the atmosphere around the toner cartridge 51.

In the present embodiment, the developer accommodated in the developing container 41 is a two-component developer in which a negatively charged nonmagnetic toner and a magnetic carrier are mixed. The nonmagnetic toner contains a colorant, a wax component, and the like in a resin such as polyester or styrene and is formed into a powder by pulverization or polymerization. In the present embodiment, particles having an average particle diameter of 7 μm are used. The magnetic carrier is obtained by applying resin coating to a surface layer of a core including ferrite particles or resin particles obtained by kneading magnetic powder.

The developing roller 44 rotates in the direction of an arrow B in FIG. 2 and conveys the developer in the direction of the regulating member 42. The layer thickness of the developer is regulated by the regulating member 42, and when the developer passes through the gap between the developing roller 44 and the regulating member 42, a developer layer having a predetermined layer thickness is formed on the developing roller 44. The developer layer is then carried and conveyed to a development region facing the photosensitive drum 1 with the rotation of the developing roller 44, and develops the electrostatic latent image formed on the surface of the photosensitive drum 1.

At the time of development, the developer on the developing roller 44 comes into contact with the photosensitive drum 1and develops the electrostatic latent image at the time of contact. Therefore, the space between the photosensitive drum 1 and the developing roller 44 is filled with the developer.

At the time of development, the developer that has not been subjected to development is then peeled off from the developing roller 44 in the peeling region in the developing container 41 with the rotation of the developing roller 44.

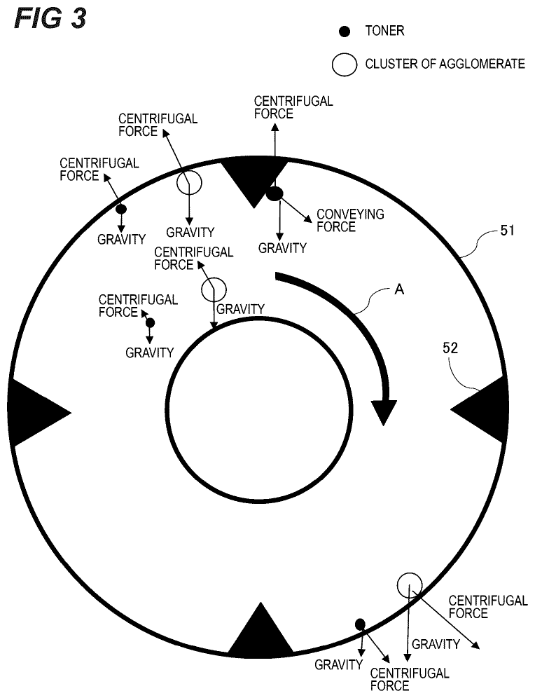

FIG. 3 is a cross-sectional view of the toner cartridge 51 of the replenishment device 5 as viewed from a direction perpendicular to the rotation axis.

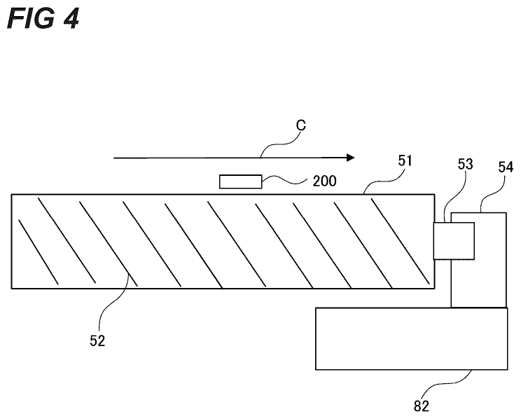

In FIG. 3, the toner is rotated as indicated by an arrow A with the rotational drive of the toner cartridge 51, and the toner is pushed by a spiral groove 52 in the toner cartridge 51. As a result, a force is applied to the toner, and the toner is discharged and conveyed by a toner cartridge discharge port 53 illustrated in FIG. 4 to be described below. In the present embodiment, the toner is discharged and conveyed by freely dropping from the groove 52, but the same applies to a configuration in which replenishment is performed using air pressure such as with a pump.

In FIG. 3, white circles ○ indicate toner of clusters of agglomerates, black circles • indicate toner that is not clusters of agglomerates, and centrifugal force and gravity associated with rotation of the toner cartridge 51 applied to the toner are indicated by arrows.

Since the toner is lightweight, both the centrifugal force and the gravity are small, but since the clusters of agglomerates are large, both the centrifugal force and the gravity are large.

In the upper portion of the toner cartridge 51, the centrifugal force and gravity are opposite to each other, and there is no difference in force applied to the clusters of agglomerates and the toner. However, in the lower portion of the toner cartridge 51, both the centrifugal force and the gravity are downward, and the force applied to the clusters of agglomerates is larger than that of the toner. Therefore, in the toner cartridge 51, clusters of agglomerates gradually gather on the outer peripheral portion of the toner cartridge 51 as the toner cartridge 51 rotates. In addition, since the centrifugal force becomes stronger at the outer peripheral portion of the toner cartridge 51, clusters of agglomerates gather at the outer peripheral portion.

Therefore, toner is mainly discharged from the toner cartridge 51, and even when there are clusters of agglomerates in the toner cartridge 51, the amount of clusters of agglomerates discharged to the outside is small.

FIG. 4 is a schematic view of the toner cartridge 51 as viewed from the side in parallel with the rotation axis.

In FIG. 4, the groove 52 is spirally arranged on the inner surface in the toner cartridge 51, and the toner in the toner cartridge 51 is conveyed in the direction of an arrow C with the rotation of the toner cartridge 51 and is finally discharged from the toner cartridge discharge port 53.

The toner discharged from the toner cartridge discharge port 53 is conveyed to the toner storage 82 through the in-toner cartridge toner discharge path 54. At this time, since the toner cartridge discharge port 53 is on the inner side in the cross-sectional view of the toner cartridge 51 in FIG. 3, the toner is discharged before the clusters of agglomerates. Therefore, the proportion of clusters of agglomerates in the toner cartridge 51 increases.

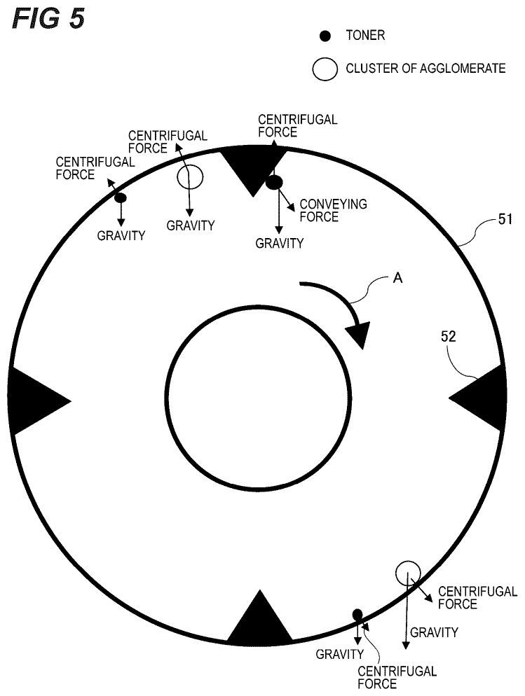

FIG. 5 is a cross-sectional view of the toner cartridge 51 as viewed from a direction perpendicular to the rotation axis in a case where the rotation speed of the toner cartridge 51 is set to a low speed.

In FIG. 5, in a case where the rotation speed of the toner cartridge 51 becomes low, the centrifugal force becomes smaller than that in FIG. 3, and thus, the gravity exceeds the centrifugal force in the upper portion of the toner cartridge 51, and the toner and the clusters of agglomerates in the outer peripheral portion of the toner cartridge 51 fall in the toner cartridge 51. Therefore, the toner in the outer peripheral portion of the toner cartridge 51 is discharged to the in-toner cartridge toner discharge path 54. At this time, in a case where there are clusters of agglomerates, the clusters of agglomerates are also discharged to the outside of the toner cartridge 51. The clusters of agglomerates are conveyed to the toner storage 82 through the in-toner cartridge toner discharge path 54 of FIG. 3 described above. Then, the clusters of agglomerates are replenished to the developing device 4 through the replenishment conveyance path 83 in FIG. 2.

In the developing device 4, the developing roller 44 rotates in the direction of the arrow B in FIG. 2 and conveys the developer in the direction of the regulating member 42. The layer thickness of the developer is regulated by the regulating member 42, and when the developer passes through the gap between the developing roller 44 and the regulating member 42, a developer layer having a predetermined layer thickness is formed on the developing roller 44. However, the clusters of agglomerates in the developer are broken when passing through the regulating member 42 and change into a short streak shape.

Thereafter, the clusters of agglomerates in the developer layer are carried and conveyed to a development region facing the photosensitive drum 1 along with the rotation of the developing roller 44, adhere to the surface of the photosensitive drum 1, and finally pass through the above-described image forming process to be formed as an image defect of a streak-like development stain.

In the configuration of the toner cartridge 51 in the present embodiment, the toner discharge performance tends to increase when the rotation speed of the toner cartridge 51 is low. For this reason, in the present embodiment, as an example of a method of making the rotation condition of the toner cartridge 51 different from that at the time of normal replenishment in the squeezing sequence of discharging the toner remaining in the toner cartridge 51, the rotation speed of the toner cartridge 51 is set to a low speed.

On the other hand, in the squeezing sequence, as a first modification of the method of making the rotation condition of the toner cartridge 51 different from that at the time of normal replenishment, it is conceivable to make the rotation speed of the toner cartridge 51 higher than that at the time of normal replenishment. Furthermore, in the squeezing sequence, as a second modification of the method of making the rotation condition of the toner cartridge 51 different from that at the time of normal replenishment, it is conceivable to rotate the toner cartridge 51 in a direction opposite to that at the time of normal replenishment. As described above, in the squeezing sequence, which method of making the rotation condition of the toner cartridge 51 different from that at the time of normal replenishment will be adopted is appropriately set in consideration of the configuration of the toner cartridge 51, the fluidity of the toner in the toner cartridge 51, and the like.

FIG. 6 is a circuit block diagram for controlling the image forming apparatus 100 of FIG. 1.

In FIG. 6, a control device 160 serving as a control unit that is a controller includes a CPU, processes image information from an image information input device 900 such as a PC or a mobile terminal, converts the image information into image formation information, and forms an image.

At this time, image information of all of yellow (Y), magenta (M), cyan (C), and black (K) is recorded in a recording device 170. The recorded image information is compared with output image information detected by an output image detection device 210 serving as an image defect determination unit that is an agglomerate determination unit that reads the output image on which the image is formed, and an abnormal image such as a development stain is detected.

A display device 910 as a display displays an instruction from the control device 160 to the user. For example, a replacement display instructing replacement of the toner cartridge 51 with a new toner cartridge is performed.

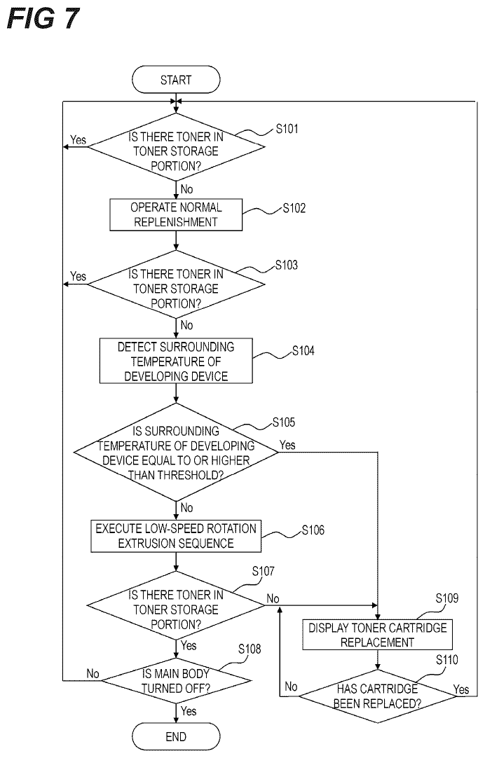

Next, a replenishment operation of the replenishment device 5 will be described with reference to a flowchart of the control device 160 of FIG. 6 illustrated in FIG. 7.

In step S101, the toner detection sensor 84 detects the presence or absence of a toner remaining amount equal to or more than a predetermined amount in the toner storage 82, and in a case where there is no toner remaining amount equal to or more than a predetermined amount, the cartridge driving device 150 rotationally drives the toner cartridge 51 at a normal replenishment rotation speed in step S102 to perform a normal toner replenishment operation.

In the present embodiment, at this time, with the cartridge driving device 150 rotating the toner cartridge 51 for 2 seconds and stopping for 1 second as one cycle, the presence or absence of a toner remaining amount equal to or more than a predetermined amount in the toner storage 82 is detected by the toner detection sensor 84 every cycle. Then, this cycle is operated for 40 cycles until it is detected that there is a toner remaining amount equal to or more than a predetermined amount in the toner storage 82.

In the present embodiment, the number of cycles is 40, but the number of cycles may be appropriately set within a range of 10 to 1000. In a case where the number of cycles is too small, there is a possibility that a replacement display instructing replacement of the toner cartridge 51 is performed even though the toner remains in the toner cartridge 51. On the other hand, in a case where the number of cycles is too large, the squeezing sequence is continuously executed until the replacement display instructing replacement of the toner cartridge 51 is performed, and thus, there is a possibility that the down time becomes long.

After the normal replenishment operation in step S102, the toner amount in the toner storage 82 is detected again by the toner detection sensor 84 in step S103, and the process returns to step S101 when it is detected that there is a toner remaining amount equal to or more than a predetermined amount. On the other hand, in a case where it is continuously detected that there is no remaining amount of toner even if the operation is continued for 40 cycles or more, it is determined that the predetermined toner is not discharged from the toner cartridge 51 and the remaining amount of toner in the toner cartridge 51 is small. In a case where it is determined in step S103 that there is no toner remaining amount, the toner squeezing sequence is performed. First, in step S104, the temperature around the developing device 4 is detected by the developing device temperature detection device 180, and in step S105, it is determined whether the temperature around the developing device 4 is equal to or higher than a threshold (predetermined value) at which clusters of agglomerates equal to or higher than a predetermined value are generated.

In the present embodiment, the threshold temperature is 44° C.

In a case where the temperature around the developing device 4 is lower than the threshold temperature, it is determined that there is no occurrence of clusters of agglomerates equal to or higher than a predetermined value, and in step S106, a toner squeezing sequence in which the rotation speed of the toner cartridge 51 is rotationally driven at a lower speed than that at the time of normal replenishment by the cartridge driving device 150 is performed. In the present embodiment, the speed is set to about 30 rpm in the toner squeezing sequence with respect to the maximum speed that can be output from the motor at the normal time, but other speeds may be used as long as the rotation speed of the toner cartridge 51 is lower than that in the normal replenishment.

In the toner squeezing sequence, the rotation time of the toner cartridge 51 is extended from that at the time of normal replenishment by the amount the rotation speed of the toner cartridge 51 becomes lower than that at the time of normal replenishment. Specifically, in the toner squeezing sequence, when the cartridge driving device 150 rotates the toner cartridge 51 for 8 seconds and stops the toner cartridge 51 for 1 second as one cycle, the presence or absence of a toner remaining amount equal to or more than a predetermined amount in the toner storage 82 is detected by the toner detection sensor 84 every cycle. Then, this cycle is operated for 25 cycles. Details of the operation of these toner squeezing sequences are the same in the second to fifth embodiments described below.

When the toner amount in the toner storage 82 is detected again by the toner detection sensor 84 and it is detected in step S107 that there is a toner remaining amount equal to or more than a predetermined amount in the toner storage 82, the process proceeds to step S108. In step S108, it is determined whether the power of the image forming apparatus 100 has been turned off. If the power has been turned off, the operation is terminated. If the power has not been turned off, the process returns to step S101 to continue the operation.

In step S107, in a case where it is continuously detected that there is no toner remaining amount equal to or more than a predetermined amount in the toner storage 82 even after 25 cycles or more, a replacement display instructing to replace the toner cartridge 51 is performed on the display device 910 in step S109, and when it is determined in step S110 that the replacement of the toner cartridge 51 has been performed, the process returns to step S101 and the operation is restarted.

On the other hand, in a case where it is determined in step S105 that the temperature around the developing device 4 is equal to or higher than the threshold, it is determined that the clusters of agglomerates equal to or higher than the predetermined value are generated, and the toner squeezing sequence in which the toner cartridge 51 is rotationally driven at a speed lower than the normal replenishment rotation speed by the cartridge driving device 150 to discharge the clusters of agglomerates, which leads to an image defect of a development stain, is not performed. Immediately thereafter (the toner cartridge 51 is not rotationally driven by the cartridge driving device 150 for further toner replenishing), in step S109, a replacement display instructing replacement of the toner cartridge 51 is performed on the display device 910, and in a case where it is determined in step S110 that replacement of the toner cartridge 51 has been performed, the process returns to step S101, and the operation is restarted.

In the present embodiment, whether or not to perform the toner squeezing sequence in which the toner cartridge 51 is rotationally driven at a lower speed than the normal replenishment rotation speed is determined by whether or not the temperature of the developing device 4 at the time when it is determined that the toner remaining amount in the toner cartridge 51 is small is a temperature equal to or higher than the threshold at which the clusters of agglomerates equal to or higher than the predetermined value are generated. However, after the toner cartridge is replaced or from the toner cartridge before the replaced toner cartridge, the number of times the temperature around the developing device 4 becomes equal to or higher than the threshold is counted up, and whether or not to perform the toner squeezing sequence of rotationally driving the toner cartridge 51 at a lower speed than the normal replenishment rotation speed may be determined based on whether or not the count-up number is equal to or more than a predetermined number.

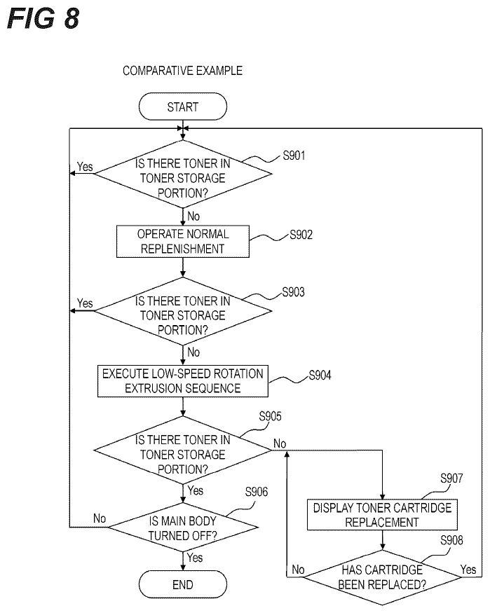

Here, for comparison with the present embodiment, a replenishment operation of the replenishment device in a case of performing a toner squeezing sequence in which the toner cartridge is rotationally driven at a speed lower than a normal replenishment rotation speed regardless of whether or not there is a possibility that clusters of agglomerates equal to or greater than a predetermined value are generated will be described with reference to the flowchart of FIG. 8 as a comparative example.

In step S901, the toner detection sensor 84 detects the presence or absence of a toner remaining amount equal to or more than a predetermined amount in the toner storage, and in a case where there is no toner remaining amount equal to or more than a predetermined amount, in step S902, a normal toner replenishment operation is performed in which the cartridge driving device rotationally drives the toner cartridge at a normal replenishment rotation speed.

After the normal replenishment operation in step S902, the toner amount in the toner storage is detected again by the toner detection sensor in step S903. In a case where it is detected that there is a toner remaining amount equal to or more than a predetermined amount, the process returns to step S901. However, in a case where it is detected that there is no toner remaining amount equal to or more than a predetermined amount, it is determined that the predetermined toner is not discharged from the toner cartridge and the toner remaining amount in the toner cartridge is small. In step S904, the toner squeezing sequence in which the toner cartridge is rotationally driven at a lower speed than the normal replenishment rotation speed by the cartridge driving device is performed without determining whether or not to perform the toner squeezing by the temperature detection around the developing device. In step S905, the toner amount in the toner storage is detected again by the toner detection sensor. The operation of the toner squeezing sequence performed at this time is similar to the operation (first embodiment) described above in step S106.

In a case where it is detected in step S905 that there is a toner remaining amount equal to or more than a predetermined amount in the toner storage, it is determined in step S906 whether the power of the image forming apparatus 100 has been turned off. If the power has been turned off, the operation is terminated. If the power has not been turned off, the process returns to step S901, and the operation is continued.

In a case where it is detected in step S905 that there is no toner remaining amount equal to or more than a predetermined amount in the toner storage, replacement display instructing replacement of the toner cartridge is performed on the display device in step S907, and in a case where it is determined in step S908 that the replacement of the toner cartridge has been performed, the process returns to step S901 and the operation is restarted.

Next, in order to verify the effect of the present embodiment on the above-described comparative example, the following experiment was performed.

In the comparative example and the present embodiment, three toner cartridges of an image with a coverage rate of 30% of yellow (Y), magenta (M), cyan (C), and black (K) were passed in a high-temperature environment and a normal environment, and an occurrence rate of a development stain was confirmed.

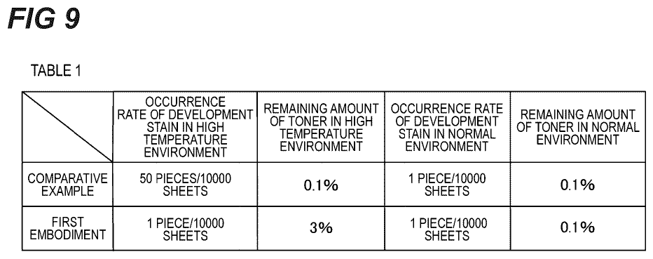

The above verification results are shown in Table 1 of FIG. 9.

As described above, in the first embodiment, as a result of detecting the temperature around the developing device 4, the toner squeezing sequence is not performed in a high-temperature environment. For this reason, as shown in Table 1 of FIG. 9, in the first embodiment, the occurrence rate of the development stain could be greatly reduced as compared with the comparative example illustrated in FIG. 8.

On the other hand, since the possibility of occurrence of a development stain is low in a normal environment, a toner squeezing sequence in which the toner cartridge is rotationally driven at a speed lower than the normal replenishment rotation speed is performed similarly to the comparative example, and thus waste of toner remaining without being used can be reduced.

### Second Embodiment

Next, a second embodiment of the present invention will be described. Note that the present embodiment has the same configuration as that of the first embodiment except for the flowchart of FIG. 7 in the first embodiment, and thus those configurations are incorporated herein by reference.

In the first embodiment, it is determined whether or not to perform the toner squeezing sequence in which the toner cartridge is rotationally driven at a lower speed than the normal replenishment rotation speed based on the temperature detection result around the developing device 4, but in the present embodiment, it is determined whether or not to perform the toner squeezing sequence in which the toner cartridge is rotationally driven at a lower speed than the normal replenishment rotation speed based on the detection result of the temperature and the humidity around the image forming apparatus 100.

The moisture amount is converted into humidity using the moisture amount sensor of the image forming apparatus humidity detection device 220 of FIG. 1. In addition, the humidity is converted into a temperature by a formula described below. As a result, it is possible to predict the occurrence rate of the development stain in consideration of the influence of humidity in addition to the temperature.

As the humidity is higher, the generation rate of clusters of agglomerates is higher. In the present embodiment, as a formula for conversion into temperature, whether or not to perform the toner squeezing sequence is determined based only on “temperature” until the humidity reaches a predetermined humidity (humidity 80% in the present embodiment). Specifically, in a case where the predetermined humidity (humidity 80% in the present embodiment) has not been reached and the predetermined temperature (temperature 30° C. in the present embodiment) has not been exceeded, the toner squeezing sequence is performed. On the other hand, in a case where the predetermined humidity (humidity 80% in the present embodiment) has not been reached and the predetermined temperature (temperature 30° C. in the present embodiment) has been exceeded, the toner squeezing sequence is not performed.

After the predetermined humidity (humidity 80% in the present embodiment) is reached, it is determined whether or not to perform the toner squeezing sequence based on the “temperature” and the “humidity”. That is, in a case where a predetermined humidity (80% in the present embodiment) has been reached, humidity temperature conversion is performed using

$$influence of humidity on temperature ( addition ) = 0.05 \times humidity$$

(for example, when the humidity is 80%, the humidity is added to the temperature detection result for 4° C.), and as a result of calculation, in a case where the temperature to which the temperature conversion amount of humidity has been added exceeds 30° C. as a threshold, the toner squeezing sequence is not performed.

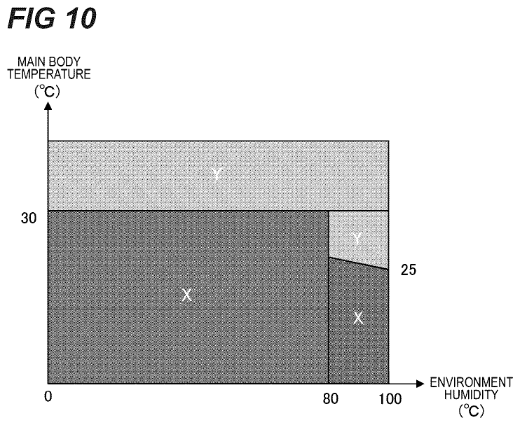

FIG. 10 illustrates a classification between an environment in which the squeezing sequence is performed and an environment in which the squeezing sequence is not performed. The squeezing sequence is performed in the region of (X) illustrated in FIG. 10, but the squeezing sequence is not performed in the region of (Y) illustrated in FIG. 10. By performing the control of the present embodiment, in a normally used guarantee environment (that is, the region of (X) illustrated in FIG. 10), the toner yield can be guaranteed by performing the squeezing sequence. On the other hand, in an environment where a development stain is likely to occur (that is, the region of (Y) illustrated in FIG. 10), the development stain can be effectively reduced by not performing the squeezing sequence.

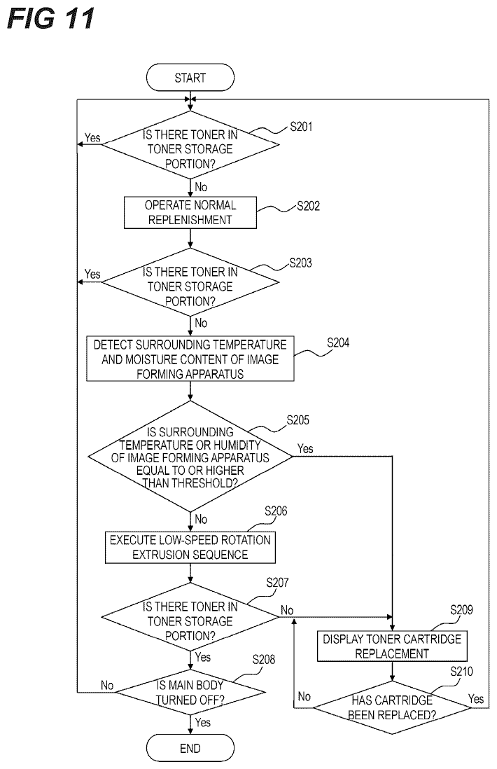

A replenishment operation of the replenishment device 5 according to the present embodiment will be described with reference to a flowchart of the control device 160 of FIG. 6 illustrated in FIG. 11.

In step S201, the toner detection sensor 84 detects the presence or absence of a toner remaining amount equal to or more than a predetermined amount in the toner storage 82, and in a case where there is no toner remaining amount equal to or more than a predetermined amount, the cartridge driving device 150 rotationally drives the toner cartridge 51 at a normal replenishment rotation speed in step S202 to perform a normal toner replenishment operation.

After the normal replenishment operation in step S202, the toner amount in the toner storage 82 is detected again by the toner detection sensor 84 in step S203. In a case where it is detected that there is a toner remaining amount equal to or more than a predetermined amount, the process returns to step S201. However, in a case where it is detected that there is no toner remaining amount equal to or more than a predetermined amount, it is determined that the predetermined toner is not discharged from the toner cartridge 51 and the toner remaining amount in the toner cartridge 51 is small. In order to perform the toner squeezing sequence, first, in step S204, the temperature around the image forming apparatus 100 is detected by the image forming apparatus temperature detection device 190, and the humidity around the image forming apparatus 100 is detected by using the moisture amount sensor of the image forming apparatus humidity detection device 220. In step S205, it is determined whether any of these is equal to or more than the threshold at which the clusters of agglomerates equal to or higher than the predetermined value is generated. In the present embodiment, the temperature (+humidity addition) value of 30° C. is set as the temperature threshold, and the humidity value of 80% is set as the humidity threshold.

If the temperature and humidity around the image forming apparatus 100 are lower than the threshold temperature in step S205, it is determined that clusters of agglomerates equal to or higher than a predetermined value do not occur, and a toner squeezing sequence in which the toner cartridge 51 is rotationally driven at a lower speed than the normal replenishment rotation speed by the cartridge driving device 150 is performed in step S206. Then, the process proceeds to step S207, where the toner amount in the toner storage is detected again.

In a case where it is detected in step S207 that there is a toner remaining amount equal to or more than a predetermined amount in the toner storage, it is determined in step S208 whether the power of the image forming apparatus 100 has been turned off. If the power has been turned off, the operation is terminated. If the power has not been turned off, the process returns to step S201 and the operation is continued.

In a case where it is detected in step S207 that there is no toner remaining amount equal to or more than a predetermined amount in the toner storage, replacement display instructing replacement of the toner cartridge is performed on the display device in step S209, and in a case where it is determined in step S210 that the replacement of the toner cartridge has been performed, the process returns to step S201 and the operation is restarted.

On the other hand, in a case where it is determined in step S205 that the temperature or humidity around the image forming apparatus 100 is equal to or higher than the threshold, it is determined that the clusters of agglomerates equal to or higher than the predetermined value are generated, and the toner cartridge 51 is rotated at a speed lower than the normal replenishment rotation speed by the cartridge driving device 150 to discharge the clusters of agglomerates, which leads to an image defect of a development stain. Therefore, the toner squeezing sequence of rotationally driving at a speed lower than the normal replenishment rotation speed is not performed, and the process immediately proceeds to step S209.

The operation after step S209 is similar to the case where the squeezing sequence is performed. Specifically, in step S210, a replacement display for instructing the display device to replace the toner cartridge is performed. Note that, also in the present embodiment, whether or not to perform the toner squeezing sequence of rotationally driving the toner cartridge 51 at a lower speed than the normal replenishment rotation speed is determined by whether or not the temperature or humidity around the image forming apparatus 100 at the time when it is determined that the toner remaining amount in the toner cartridge 51 is small is a temperature or humidity equal to or higher than the threshold at which the clusters of agglomerates equal to or higher than the predetermined value are generated. However, after the toner cartridge is replaced or from the toner cartridge before the replaced toner cartridge, the number of times the temperature or humidity around the image forming apparatus 100 becomes equal to or higher than the threshold is counted up, and whether or not to perform the toner squeezing sequence of rotationally driving the toner cartridge 51 at a lower speed than the normal replenishment rotation speed may be determined based on whether or not the count-up number is equal to or more than a predetermined number.

Here, in order to verify the effect of the present embodiment, the following experiment was performed in the same manner as in the first embodiment

In the comparative example illustrated in FIG. 8, the first embodiment, and the present embodiment, three toner cartridges of an image with a coverage rate of 30% of yellow (Y), magenta (M), cyan (C), and black (K) were passed in a high-temperature environment and a normal environment, and an occurrence rate of a development stain was confirmed.

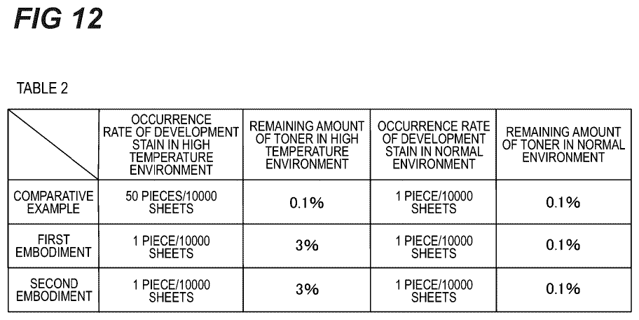

The above verification results are shown in Table 2 of FIG. 12.

As described above, in the second embodiment, as a result of detecting the temperature and humidity around the image forming apparatus 100, the toner squeezing sequence is not performed in a high-temperature environment. Therefore, as shown in Table 2 of FIG. 12, in the second embodiment, the occurrence rate of the development stain could be greatly reduced as compared with the comparative example illustrated in FIG. 8.

On the other hand, since the possibility of occurrence of a development stain is low in a normal environment, a toner squeezing sequence in which the toner cartridge is rotationally driven at a speed lower than the normal replenishment rotation speed is performed similarly to the comparative example, and thus waste of toner remaining without being used can be reduced.

### Third Embodiment

Next, a third embodiment of the present invention will be described. Note that the present embodiment has the same configuration as that of the first embodiment except for the flowchart of FIG. 7 in the first embodiment, and thus these configurations are incorporated herein by reference.

In the first embodiment, when the temperature detection result around the developing device 4 is equal to or more than the threshold, the toner squeezing sequence is not performed to prevent the occurrence of the development stain due to the discharge of the clusters of agglomerates. In addition, in the second embodiment, in a case where the detection result of the temperature and humidity around the image forming apparatus 100 is equal to or more than the threshold, the toner squeezing sequence is not performed, so that the occurrence of the development stain due to the discharge of the clusters of agglomerates is prevented. On the other hand, in the present embodiment, in a case where the detection result of the temperature and humidity around the image forming apparatus 100 is equal to or more than the threshold, instead of the toner squeezing sequence in which the toner cartridge 51 is changed to a low speed and rotationally driven, the toner squeezing sequence in which the toner cartridge 51 is rotationally driven at a normal high replenishment rotation speed is performed rather than not performing the toner squeezing sequence.

As a result, since the toner cartridge 51 is not rotated at a low speed, development stain can be suppressed without discharging clusters of agglomerates.

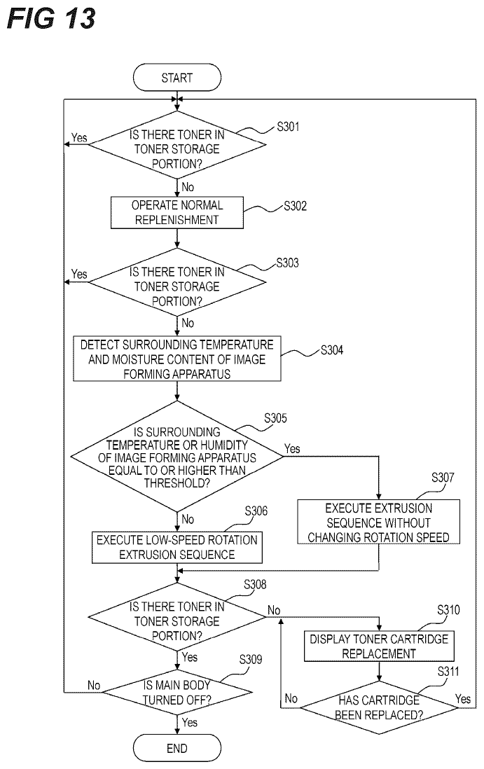

A replenishment operation of the replenishment device 5 according to the present embodiment will be described with reference to a flowchart of the control device 160 of FIG. 6 illustrated in FIG. 13.

In step S301, the toner detection sensor 84 detects the presence or absence of a toner remaining amount equal to or more than a predetermined amount in the toner storage 82, and in a case where there is no toner remaining amount equal to or more than a predetermined amount, the cartridge driving device 150 rotationally drives the toner cartridge 51 at a normal replenishment rotation speed in step S302 to perform a normal toner replenishment operation.

After the normal replenishment operation in step S302, the toner amount in the toner storage 82 is detected again by the toner detection sensor 84 in step S303. In a case where it is detected that there is a toner remaining amount equal to or more than a predetermined amount, the process returns to step S301. However, in a case where it is detected that there is no toner remaining amount equal to or more than a predetermined amount, it is determined that the predetermined toner is not discharged from the toner cartridge 51 and the toner remaining amount in the toner cartridge 51 is small. In order to perform the toner squeezing sequence, first, the temperature and humidity around the image forming apparatus 100 are detected in step S304. After the temperature and humidity around the image forming apparatus 100 are detected, it is determined in step S305 whether to perform the squeezing sequence. The determination criterion as to whether to perform the squeezing sequence is the same as that of the second embodiment.

If the temperature calculated in step S305 (the temperature to which the temperature converted amount of humidity is added) is lower than the threshold temperature, it is determined that there is no occurrence of clusters of agglomerates equal to or higher than a predetermined value, and in step S306, a toner squeezing sequence is performed in which the toner cartridge 51 is rotationally driven at a lower speed than the normal replenishment rotation speed by the cartridge driving device 150.

On the other hand, in a case where it is determined that the temperature calculated in step S305 (the temperature to which the temperature converted amount of humidity is added) is equal to or higher than the threshold, it is determined that the clusters of agglomerates equal to or higher than the predetermined value are generated, and the toner squeezing sequence in which the toner cartridge 51 is rotated at a speed lower than the normal replenishment rotation speed by the cartridge driving device 150 and the clusters of agglomerates are discharged, which leads to the image defect of the development stain, is not performed, and the toner squeezing sequence (squeezing sequence without changing the rotation speed) in which the toner cartridge 51 is rotationally driven while the toner cartridge 51 is rotated at a high speed that is the normal replenishment rotation speed without rotating the toner cartridge at a low speed is performed in step S307.

Then, after performing both the toner squeezing sequence in which the toner cartridge 51 is rotationally driven at a low speed in step S306 and the toner squeezing sequence in which the toner cartridge 51 is rotationally driven without being rotated at a low speed and the toner cartridge 51 is rotationally driven while being rotated at a high speed that is a normal replenishment rotation speed in step S307, the toner amount in the toner storage is detected again by the toner detection sensor 84 in step S308.

In a case where it is detected in step S308 that there is a toner remaining amount equal to or more than a predetermined amount in the toner storage, it is determined in step S309 whether the power of the image forming apparatus 100 has been turned off. If the power has been turned off, the operation is terminated. If the power has not been turned off, the process returns to step S301, and the operation is continued.

In a case where it is detected in step S308 that there is no toner remaining amount equal to or more than a predetermined amount in the toner storage, replacement display instructing replacement of the toner cartridge is performed on the display device in step S310, and when it is determined in step S311 that replacement of the toner cartridge has been performed, the process returns to step S301 and the operation is restarted.

Note that, also in the present embodiment, whether or not to perform the toner squeezing sequence of rotationally driving the toner cartridge 51 at a lower speed than the normal replenishment rotation speed is determined by whether or not the temperature or humidity around the image forming apparatus 100 at the time when it is determined that the toner remaining amount in the toner cartridge 51 is small is a temperature or humidity equal to or higher than the threshold at which the clusters of agglomerates equal to or higher than the predetermined value are generated. However, after the toner cartridge is replaced or from the toner cartridge before the replaced toner cartridge, the number of times the temperature around the developing device 4 becomes equal to or higher than the threshold is counted up, and whether or not to perform the toner squeezing sequence of rotationally driving the toner cartridge 51 at a lower speed than the normal replenishment rotation speed may be determined based on whether or not the count-up number is equal to or more than a predetermined number.

Here, in order to verify the effect of the present embodiment, the following experiment was performed in the same manner as in the first and second embodiments.

In the comparative example illustrated in FIG. 8, the first and second embodiments, and the present embodiment, three toner cartridges of an image with a coverage rate of 30% of yellow (Y), magenta (M), cyan (C), and black (K) were passed in a high-temperature environment and a normal environment, and an occurrence rate of a development stain was confirmed.

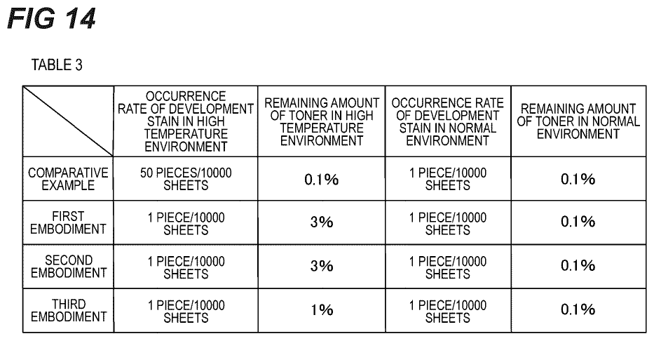

The above verification results are shown in Table 3 of FIG. 14.

As described above, in the third embodiment, as a result of detecting the temperature and humidity around the image forming apparatus 100, when the environment is a high-temperature environment, the toner squeezing sequence in which the toner cartridge is rotationally driven at a normal high replenishment rotation speed is performed instead of the toner squeezing sequence in which the toner cartridge is changed to a low speed and rotationally driven. For this reason, as shown in Table 3 of FIG. 14, in the third embodiment, the occurrence rate of the development stain could be greatly reduced as compared with the comparative example illustrated in FIG. 8. In addition, since the toner squeezing sequence is performed while the toner cartridge is kept at the normal high-speed replenishment rotation speed even in a high-temperature environment, waste of toner remaining without being used can be reduced although not as much as in the comparative example.

On the other hand, since the possibility of occurrence of a development stain is low in a normal environment, a toner squeezing sequence in which the toner cartridge is rotationally driven at a speed lower than the normal replenishment rotation speed is performed similarly to the comparative example, and thus waste of toner remaining without being used can be reduced.

### Fourth Embodiment

Next, a fourth embodiment of the present invention will be described. Note that the present embodiment has the same configuration as that of the first embodiment except for the flowchart of FIG. 7 in the first embodiment, and thus those configurations are incorporated herein by reference.

Whether or not to perform the toner squeezing sequence in which the toner cartridge is rotationally driven at a lower speed than the normal replenishment rotation speed is determined by the temperature detection result around the developing device 4 in the first embodiment and by the temperature detection result around the image forming apparatus 100 in the second and third embodiments. However, in the present embodiment, whether or not to perform the toner squeezing sequence in which the toner cartridge is rotationally driven at a lower speed than the normal replenishment rotation speed is determined by the temperature detection result around the toner cartridge 51.

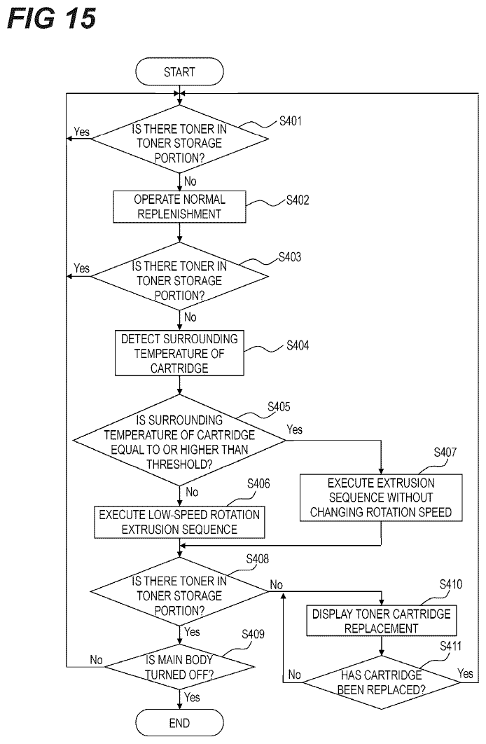

A replenishment operation of the replenishment device 5 according to the present embodiment will be described with reference to a flowchart of the control device 160 of FIG. 6 illustrated in FIG. 15.

In step S401, the toner detection sensor 84 detects the presence or absence of a toner remaining amount equal to or more than a predetermined amount in the toner storage 82, and in a case where there is no toner remaining amount equal to or more than a predetermined amount, the cartridge driving device 150 rotationally drives the toner cartridge 51 at a normal replenishment rotation speed in step S402 to perform a normal toner replenishment operation.

After the normal replenishment operation in step S402, the toner amount in the toner storage 82 is detected again by the toner detection sensor 84 in step S403, and the process returns to step S401 when it is detected that there is a toner remaining amount equal to or more than a predetermined amount. However, in a case where it is detected that there is no toner remaining amount equal to or more than a predetermined amount, it is determined that the predetermined toner is not discharged from the toner cartridge 51 and the toner remaining amount in the toner cartridge 51 is small. In order to perform the toner squeezing sequence, first, in step S404, the temperature around the toner cartridge 51 is detected by the toner cartridge temperature detection device 200, and in step S405, it is determined whether the temperature around the toner cartridge 51 is a temperature equal to or higher than a threshold at which the clusters of agglomerates equal to or higher than the predetermined value are generated. In the present embodiment, the threshold temperature is 37° C.

If the temperature around the toner cartridge 51 is lower than the threshold temperature, it is determined that clusters of agglomerates equal to or higher than a predetermined value do not occur, and in step S406, a toner squeezing sequence is performed in which the toner cartridge 51 is rotationally driven at a lower speed than the normal replenishment rotation speed by the cartridge driving device 150.

On the other hand, in a case where it is determined that the temperature around the toner cartridge 51 is equal to or higher than the threshold, it is determined that the clusters of agglomerates equal to or higher than the predetermined value are generated, and the toner squeezing sequence in which the toner cartridge 51 is rotated at a speed lower than the normal replenishment rotation speed by the cartridge driving device 150 and the clusters of agglomerates are discharged, which leads to an image defect of a development stain, is not performed, and the toner squeezing sequence (squeezing sequence without changing the rotation speed) in which the toner cartridge 51 is rotationally driven while being rotated at a high speed that is the normal replenishment rotation speed without rotating the toner cartridge 51 at a low speed is performed in step S407.

Then, after performing both the toner squeezing sequence in which the toner cartridge 51 is rotationally driven at a low speed in step S406 and the toner squeezing sequence in which the toner cartridge 51 is rotationally driven without rotating at a low speed and the toner cartridge 51 is rotationally driven at a normal high speed in step S407, the toner amount in the toner storage is detected again by the toner detection sensor 84 in step S408.

In a case where it is detected in step S408 that there is a toner remaining amount equal to or more than a predetermined amount in the toner storage, it is determined in step S409 whether the power of the image forming apparatus 100 has been turned off. If the power has been turned off, the operation is terminated. If the power has not been turned off, the process returns to step S401, and the operation is continued.

In a case where it is detected in step S408 that there is no toner remaining amount equal to or more than a predetermined amount in the toner storage, replacement display instructing replacement of the toner cartridge is performed on the display device in step S410, and in a case where it is determined in step S411 that the replacement of the toner cartridge has been performed, the process returns to step S401 and the operation is restarted.

Note that, also in the present embodiment, whether or not to perform the toner squeezing sequence of rotationally driving the toner cartridge 51 at a lower speed than the normal replenishment rotation speed is determined by whether or not the temperature around the toner cartridge 51 at the time when it is determined that the toner remaining amount in the toner cartridge 51 is small is a temperature equal to or higher than the threshold at which the clusters of agglomerates equal to or higher than the predetermined value are generated. However, after the toner cartridge is replaced or from the toner cartridge before the replaced toner cartridge, the number of times the temperature around the toner cartridge becomes equal to or higher than the threshold is counted up, and whether or not to perform the toner squeezing sequence of rotationally driving the toner cartridge 51 at a lower speed than the normal replenishment rotation speed may be determined based on whether or not the count-up number is equal to or more than a predetermined number.

Here, in order to verify the effect of the present embodiment, the following experiment was performed in the same manner as in the first to third embodiments.

With respect to the above-described comparative example, the first to third embodiments, and the present embodiment illustrated in FIG. 8, in a high-temperature environment and a normal environment, images of yellow (Y), magenta (M), cyan (C), and black (K) with a coverage rate of 30% were passed for three toner cartridges, and an occurrence rate of a development stain was confirmed.

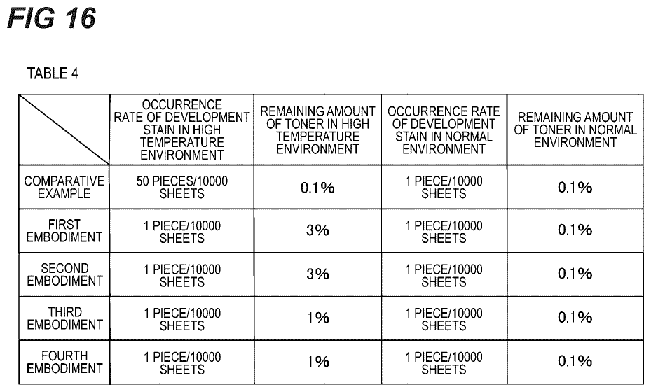

The above verification results are shown in Table 4 of FIG. 16.

As described above, in the fourth embodiment, as a result of detecting the temperature around the toner cartridge 51, in a case where the environment is a high-temperature environment, the toner squeezing sequence in which the toner cartridge is rotationally driven at a normal high replenishment rotation speed is performed instead of the toner squeezing sequence in which the toner cartridge is changed to a low speed and rotationally driven. Therefore, as shown in Table 4 of FIG. 16, in the fourth embodiment, the occurrence rate of the development stain could be greatly reduced as compared with the comparative example illustrated in FIG. 8. In addition, since the toner squeezing sequence is performed while the toner cartridge is kept at the normal high-speed replenishment rotation speed even in a high-temperature environment, waste of toner remaining without being used can be reduced although not as much as in the comparative example.

On the other hand, since the possibility of occurrence of a development stain is low in a normal environment, a toner squeezing sequence in which the toner cartridge is rotationally driven at a speed lower than the normal replenishment rotation speed is performed similarly to the comparative example, and thus waste of toner remaining without being used can be reduced.

### Fifth Embodiment

Next, a fifth embodiment of the present invention will be described. Note that the present embodiment has the same configuration as that of the first embodiment except for the flowchart of FIG. 7 in the first embodiment, and thus those configurations are incorporated herein by reference.

In the present embodiment, the output image detection device 210 measures the number of development stains caused by clusters of agglomerates of toner, and it is determined whether or not to perform a toner squeezing sequence in which the toner cartridge is rotationally driven at a speed lower than a normal replenishment rotation speed based on the measurement result.

According to the present embodiment, since the output image detection device 210 directly measures the number of occurrences of development stains and determines image defects, a more accurate effect can be obtained.

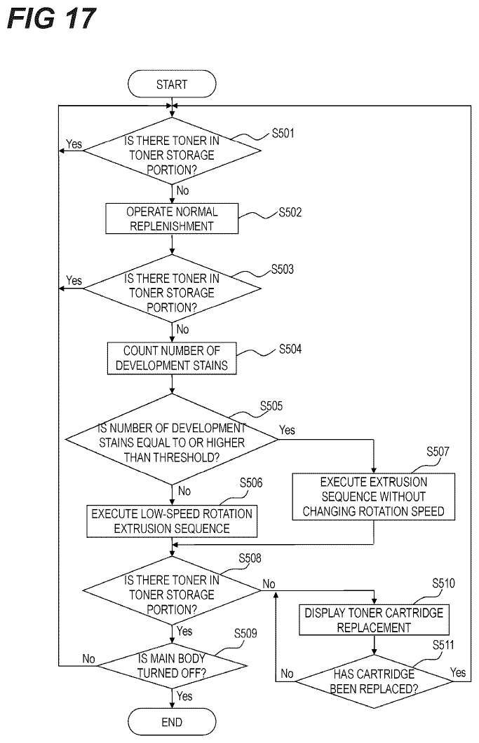

A replenishment operation of the replenishment device 5 according to the present embodiment will be described with reference to a flowchart of the control device 160 of FIG. 6 illustrated in FIG. 17.

In step S501, the toner detection sensor 84 detects the presence or absence of a toner remaining amount equal to or more than a predetermined amount in the toner storage 82, and in a case where there is no toner remaining amount equal to or more than a predetermined amount, the cartridge driving device 150 rotationally drives the toner cartridge 51 at a normal replenishment rotation speed in step S502 to perform a normal toner replenishment operation.

After the normal replenishment operation in step S502, the toner amount in the toner storage 82 is detected again by the toner detection sensor 84 in step S503. In a case where it is detected that there is a toner remaining amount equal to or more than a predetermined amount, the processing returns to step S501. However, in a case where it is detected that there is no toner remaining amount equal to or more than a predetermined amount, it is determined that the predetermined toner is not discharged from the toner cartridge 51 and the toner remaining amount in the toner cartridge 51 is small. In order to perform the toner squeezing sequence, first, in step S504, the number of development stains from the previous replacement of the toner cartridge 51 to the present time is counted by the output image detection device 210 in FIG. 6, and in step S505, it is determined whether the number of development stains (development stain occurrence rate) is equal to or more than the threshold. In the present embodiment, the threshold number is 1 piece/2500 sheets or more.

If the number of development stains is smaller than the threshold, it is determined that there is no occurrence of clusters of agglomerates equal to or more than a predetermined value, and in step S206, a toner squeezing sequence is performed in which the cartridge driving device 150 rotationally drives the toner cartridge 51 at a lower speed than the normal replenishment rotation speed.

On the other hand, in a case where it is determined that the number of development stains is equal to or larger than the threshold, it is determined that the clusters of agglomerates equal to or higher than the predetermined value are generated, and a toner squeezing sequence in which the toner cartridge 51 is rotated at a speed lower than the normal replenishment rotation speed by the cartridge driving device 150 and the clusters of agglomerates are discharged, which leads to an image defect of the development stain, is not performed, and a toner squeezing sequence (squeezing sequence without changing the rotation speed) in which the toner cartridge 51 is rotationally driven while being rotated at a high speed that is a normal replenishment rotation speed without rotating the toner cartridge 51 at a low speed is performed in step S507.

Then, after performing both the toner squeezing sequence in which the toner cartridge 51 is rotationally driven at a low speed in step S506 and the toner squeezing sequence in which the toner cartridge 51 is rotationally driven without rotating at a low speed and the toner cartridge 51 is rotationally driven at a high speed that is a normal replenishment rotation speed in step S507, the toner amount in the toner storage is detected again by the toner detection sensor 84 in step S508.

In a case where it is detected in step S508 that there is a toner remaining amount equal to or more than a predetermined amount in the toner storage, it is determined in step S509 whether the power of the image forming apparatus 100 has been turned off. If the power has been turned off, the operation is terminated. If the power has not been turned off, the process returns to step S501, and the operation is continued.

In a case where it is detected in step S508 that there is no toner remaining amount equal to or more than a predetermined amount in the toner storage, replacement display instructing replacement of the toner cartridge is performed on the display device in step S510, and in a case where it is determined in step S511 that the replacement of the toner cartridge has been performed, the process returns to step S501 and the operation is restarted.

Here, in order to verify the effect of the present embodiment, the following experiment was performed in the same manner as in the first to fourth embodiments.

With respect to the above-described comparative example, the first to fourth embodiments, and the present embodiment illustrated in FIG. 8, in a high-temperature environment and a normal environment, images of yellow (Y), magenta (M), cyan (C), and black (K) with a coverage rate of 30% were passed for three toner cartridges, and an occurrence rate of a development stain was confirmed.

Furthermore, in the present embodiment, a third experiment was also performed on the assumption that the toner cartridge 51 left in a high-temperature environment is used immediately after it enters a normal environment at the change of seasons.

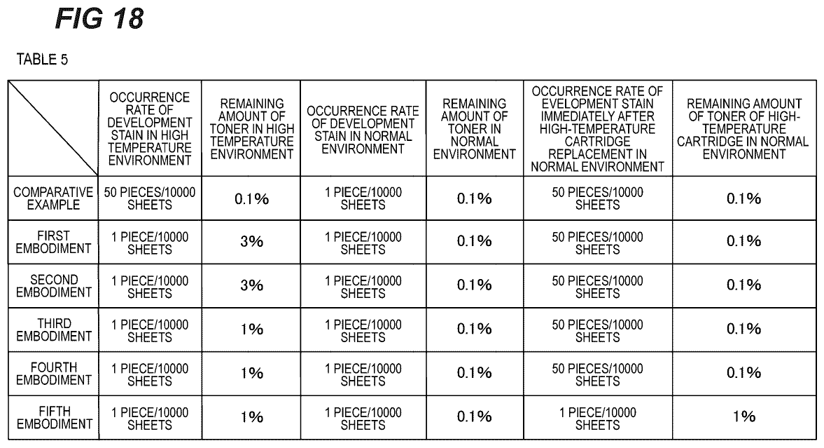

The above verification results are shown in Table 5 of FIG. 18.

As shown in Table 5 of FIG. 18, in the fifth embodiment, the occurrence rate of development stains could be greatly reduced as compared with the comparative example.

Furthermore, even in a special case where the toner cartridge left in a high-temperature environment is used in a normal environment, the present embodiment can suppress the occurrence of development stain as compared with the comparative example.

In addition, even in a case where the number of development stains is equal to or larger than the threshold, the toner squeezing sequence is performed while the toner cartridge is at the normal high-speed replenishment rotation speed. Therefore, although not as much as in the comparative example, waste of toner remaining without being used can be reduced.

On the other hand, since the possibility of occurrence of a development stain is low in a normal environment, a toner squeezing sequence in which the toner cartridge is rotationally driven at a speed lower than the normal replenishment rotation speed is performed similarly to the comparative example, and thus waste of toner remaining without being used can be reduced.

Note that, in the third to fifth embodiments described above, in a case where the possibility of occurrence of a development stain is high, the toner squeezing sequence (squeezing sequence without changing the rotation speed) is performed at a replenishment rotation speed of the toner cartridge at a normal high speed. However, in this case, similarly to the first embodiment, a modification in which the toner squeezing sequence itself is not performed may be used. Alternatively, in the third to fifth embodiments described above, in a case where the possibility of the occurrence of the development stain is high, instead of performing the above-described squeezing sequence without changing the rotation speed, a modification in which the toner squeezing sequence in which the rotation speed is faster than that in the low-speed rotation squeezing sequence and the rotation speed is slower than that in the normal replenishment is performed may be used.

Further, in the first embodiment, it is determined whether or not to perform the toner squeezing sequence of rotating the toner cartridge at a lower speed than the normal replenishment rotation speed based on the temperature detection result around the developing device, and in the fourth embodiment, it is determined based on the temperature detection result around the cartridge. On the other hand, also in the fifth embodiment, similarly to the second and third embodiments, the humidity detection device may be installed in the developing device or the cartridge, and the humidity detection result around the developing device and the humidity detection result around the cartridge may be used together for determining whether or not to perform the toner squeezing sequence of rotating the toner cartridge at a lower speed than the normal high-speed replenishment rotation speed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-093929, filed Jun. 10, 2024 and No. 2025-026667, filed Feb. 21, 2025, which are hereby incorporated by reference herein in their entirety.

What is claimed is

1. An image forming apparatus comprising:
an image bearing member;
a toner container configured to accommodate toner;
a developer carrier configured to carry a developer including the toner to develop an electrostatic latent image formed on the image bearing member;
a toner amount detection portion configured to detect an amount of the toner accommodated in the toner container;
a rotatable toner cartridge configured to accommodate toner for replenishing the toner container;
a driving portion configured to rotationally drive the toner cartridge;
a controller configured to control the driving portion;
a temperature detection portion configured to detect temperature; and
a display,
wherein
the controller executes a first operation of controlling the driving portion to rotationally drive the toner cartridge under a first rotation condition for replenishing the toner container with toner, and
in a case where the toner amount detected by the toner amount detection portion is smaller than a predetermined amount after the first operation is executed, based on the temperature detected by the temperature detection portion, determines whether to execute a second operation of controlling the driving portion to rotationally drive the toner cartridge under a second rotation condition different from the first rotation condition, or execute a third operation of controlling the display to perform a display for prompting replacement of the toner container without executing the second operation.

2. The image forming apparatus according to claim 1, wherein
in a case where the toner amount detected by the toner amount detection portion is smaller than the predetermined amount and the temperature detected by the temperature detection portion is lower than a predetermined value after the first operation is executed, the controller executes the second operation, and
in a case where the toner amount detected by the toner amount detection portion is smaller than the predetermined amount and the temperature detected by the temperature detection portion is equal to or higher than the predetermined value after the first operation is executed, the controller executes the third operation without executing the second operation.

3. The image forming apparatus according to claim 1, further comprising:
a humidity detection portion configured to detect humidity,
wherein
in a case where the toner amount detected by the toner amount detection portion is smaller than the predetermined amount after the first operation is executed, the controller determines whether to execute the second operation or execute the third operation without executing the second operation based on the temperature detected by the temperature detection portion and the humidity detected by the humidity detection portion.

4. The image forming apparatus according to claim 1, wherein
the first rotation condition is a first rotation speed, and
the second rotation condition is a second rotation speed lower than the first rotation speed.

5. An image forming apparatus comprising:
an image bearing member;
a toner container configured to accommodate toner;
a developer carrier configured to carry a developer including the toner to develop an electrostatic latent image formed on the image bearing member;
a toner amount detection portion configured to detect an amount of the toner accommodated in the toner container;
a rotatable toner cartridge configured to accommodate toner for replenishing the toner container;
a driving portion configured to rotationally drive the toner cartridge;
a controller configured to control the driving portion; and
a temperature detection portion configured to detect temperature,
wherein
the controller executes a first operation of controlling the driving portion to rotationally drive the toner cartridge at a first rotation speed for replenishing the toner container with toner, and
in a case where the toner amount detected by the toner amount detection portion is smaller than a predetermined amount after the first operation is executed, based on the temperature detected by the temperature detection portion, determines whether to execute a second operation of controlling the driving portion to rotationally drive the toner cartridge at a second rotation speed lower than the first rotation speed, or execute a third operation of controlling the driving portion to rotationally drive the toner cartridge at a third rotation speed higher than the second rotation speed.

6. The image forming apparatus according to claim 5, wherein
in a case where the toner amount detected by the toner amount detection portion is smaller than the predetermined amount and the temperature detected by the temperature detection portion is lower than a predetermined value after the first operation is executed, the controller executes the second operation, and
in a case where the toner amount detected by the toner amount detection portion is smaller than the predetermined amount and the temperature detected by the temperature detection portion is equal to or higher than the predetermined value after the first operation is executed, the controller executes the third operation.

7. The image forming apparatus according to claim 5, further comprising:
a humidity detection portion configured to detect humidity,
wherein
in a case where the toner amount detected by the toner amount detection portion is smaller than the predetermined amount after the first operation is executed, the controller determines whether to execute the second operation or execute the third operation based on the temperature detected by the temperature detection portion and the humidity detected by the humidity detection portion.

8. The image forming apparatus according to claim 5, wherein
the third rotation speed is the same as the first rotation speed.
